(19) United States
(12) Patent Application Publication
(10) Pub. No.: US 2006/0007520 A1
(43) Pub. Date: Jan. 12, 2006

(54) Method of manufacturing organic thin film element, method of manufacturing electro-optic device, and method of manufacturing electronic equipment

(75) Inventors: Atsushi Takakuwa, Shiojiri-shi (JP); Tatsuya Shimoda, Fujimi-machi (JP); Masahiro Furusawa, Chino-shi (JP); Tadaoki Mitani, Nomi-shi (JP); Hisato Yamaguchi, Ichihara-shi (JP)

Correspondence Address: OLIFF & BERRIDGE, PLC, P.O. BOX 19928, ALEXANDRIA, VA, 22320, US

(73) Assignees: SEIKO EPSON CORPORATION, Tokyo (JP); Tadaoki MITANI, Nomi-shi (JP)

(21) Appl. No.: 11/141,108

(22) Filed: Jun. 1, 2005

(30) Foreign Application Priority Data
Jul. 9, 2004 (JP) 2004-203917

(51) Int. Cl. G02F 1/153

(52) U.S. Cl. 359/275

(57) ABSTRACT

A method of manufacturing an organic thin film element including an organic thin film between a pair of thin film electrodes with at least one transparent electrode includes forming the transparent electrode by atomizing a material liquid containing a transparent-electrode forming material onto a base material; and forming the organic thin film on the transparent electrode. The organic thin film element is capable of simply providing an organic thin film element having a long element life. A method of manufacturing an electro-optic device as well as a method of manufacturing electronic equipment by using the above method are described.

### BACKGROUND

The exemplary embodiments relate to a method of manufacturing an organic thin film device, and to a method of manufacturing an electro-optic device and electronic equipment.

An organic electroluminescence element (hereinafter, also referred to as an organic-EL element) is a self-luminous element that emits light itself by flowing an electric current, and the organic electroluminescence element is also excellent in visibility and in impact resistance, and further has an excellent characteristic of a lower power dissipation as compared with an inorganic EL. Accordingly, because of such excellent characteristics, the organic-EL element attracts attention as the next generation display device.

The organic-EL element is typically composed of a substrate, an anode, an organic luminescent layer and a cathode. In the organic-EL element, it is important that a flatness of the surface of a substrate to be the foundation is high. If a transparent electrode is formed as the anode or the cathode on a coarse substrate having microscopic irregularities in the surface, many dark spots will occur in the luminescent face of the organic-EL element, and the element life of the organic-EL element also will be extremely shorter.

This is due to the film thickness of the transparent electrode used for the organic-EL element being thin. Namely, the film thickness of the transparent electrode used for the organic-EL element is several hundred nm, and even if the irregularities in the surface of the substrate are microscopic irregularities of several nm, the influence from this microscopic irregularities will also strongly reflect on the surface of the transparent electrode. Therefore, the film thickness of the organic luminescent layer, or the like, formed on this transparent electrode also will be not uniform. Consequently, because a lot of dark spots occur in the luminescent face of the organic-EL element or a short path (a short circuit) occurs to disconnect, the element life will be shorter.

In order to circumvent such inconveniences, in the related art a process of polishing the surface of the transparent electrode to be smooth has been carried out as disclosed in, for example, Japanese Unexamined Patent Publication No. 2003-308971.

### SUMMARY

However, the polishing process is costly, and involves many process steps, and thus it takes time to carry out the processes.

Therefore, the exemplary embodiments provide a method of manufacturing an organic thin film element having a long element life by using a simple method, and a method of manufacturing an electro-optic device as well as a method of manufacturing electronic equipment by using the above method.

Address or solve the above-described problem, a method of manufacturing an organic thin film element including an organic thin film between a pair of thin film electrodes with at least one transparent electrode, includes: forming a transparent electrode by atomizing a material liquid containing a transparent-electrode forming material onto a base material; and forming an organic thin film on the transparent electrode.

According to this method, because the film is formed on the base material by atomizing the liquid which is to serve as the material of the transparent electrode, the surface of the formed transparent electrode can be smoothed. Namely, the atomized liquid will have an extremely microscopic particle size, and therefore can also enter inside the microscopic concave portion in the surface of the base material. Moreover, because the liquid component will still remain in the atomized material liquid even at the time of adhering, the atomized material liquid will flow when adhered to the surface of the base material. Thereby, the transparent electrode whose surface is nearly smoothed can be obtained. Consequently, the transparent electrode having an excellent smoothness can be obtained without depending on a special process, and thus the organic thin film element having a long element life can be manufactured.

Here, the material liquid may be just a liquid including a material (hereinafter, also referred to as a transparent-electrode forming material) for forming the transparent electrode. The material liquid composed of dispersing or dissolving the transparent-electrode forming material into a solvent may be used, and the form thereof is no object.

It is preferable to use, as the material liquid, the liquid composed of a material having a high affinity with the base material. Thereby, the fluidity becomes excellent when the material liquid adheres to the surface of the base material, and thus the surface of the transparent electrode can be made smoother, and further the adhesion to the base material becomes excellent. In addition, the material having a high affinity with the base material (or a target material intended to be adhered) includes the materials wherein adhesion between the transparent-electrode forming material contained in the material liquid and the base material (or a target material intended to be adhered) is excellent, in addition to the materials wherein wettability between the solvent contained in the material liquid and the base material (or a target material intended to be adhered) is excellent.

As the base film of the transparent electrode, it is preferable to form a film having a high affinity with the material liquid rather than with the base material on the base material. Thereby, the fluidity will be excellent when the material liquid adheres regardless of the affinity between the material liquid and the surface of the base material. Thus, the surface of the transparent electrode can be made smoother, and furthermore the adhesion to the base material becomes excellent. Therefore, the range of the choice for the material liquid will be extended.

The base layer is preferably a self-assembled monolayer. Because with the self-assembled monolayer (hereinafter, also referred to as SAM), a stable and almost uniform film can be formed, it is possible to retain the affinity with the material liquid for a long period of time. Consequently, the adhesion between the material liquid and the base material can be further increased.

It is preferable to deposit the transparent electrode layer in advance on the base material by a method other than the atomizing before the film-forming of the transparent electrode by the atomizing. Here, the method other than the atomizing includes a sputtering method or a spraying method, for example. Thereby, it is possible to adjust the irregularities in the surface by atomizing after having film-formed to a nearly necessary film thickness in advance by using a method that enables the film-forming (depositing) at a higher speed than by using the atomizing. Thus, the throughput will be improved as compared with the case where the whole film-forming is carried out by atomizing.

The particle diameter of the atomized material liquid is, for example, 10 μm or less. With such a particle diameter, most of the particles of the material liquid which have been atomized to the inside of the microscopic irregularities in the surface of the base material can penetrate thereinto, and thus the surface of the transparent electrode can be made smoother.

As the base material, non surface-treated base materials can be used. According to the exemplary embodiment, because the material liquid in the form of microscopic particles is adhered to the surface of the base material by atomizing, the particles adhered to the surface of the base material can flow and also penetrate into the microscopic irregularities. Consequently, even with the base material to which smoothing process such as polishing or the like has not been carried out, a transparent electrode film having a smooth surface can be formed using the method of the exemplary embodiments.

The organic thin film element includes an organic thin film semiconductor element, for example. Moreover, an organic electroluminescence element is assumed to be also included in the organic semiconductor element.

The method of manufacturing the organic thin film element of the exemplary embodiments can be suitably used for the method of manufacturing an electro-optic device, and for the method of manufacturing electronic equipment.

### BRIEF DESCRIPTION OF THE DRAWINGS

FIGS. 1A-1F are schematics for explaining an example of a method of manufacturing an organic thin film element in an exemplary embodiment of the present invention;

FIGS. 2A and 2B are schematics for explaining a method of manufacturing the organic thin film element in another exemplary embodiment;

FIGS. 3A and 3B are schematics for explaining a method of manufacturing the organic thin film element in another exemplary embodiment;

FIG. 4 is a schematic showing an example of an organic-EL device in an exemplary embodiment;

FIGS. 5A-5D are schematics showing examples of various kinds of electronic equipment including an electro-optic device, for example, an organic-EL display device, in an exemplary embodiment;

FIGS. 6A and 6B are schematics showing examples of various kinds of electronic equipments constituted including the electro-optic device, for example, an organic-EL display device, in an exemplary embodiment;

FIG. 7 is a schematic showing the results of observation of the surface of an ITO film formed by a LSMCD method by way of an atomic force microscope in an exemplary embodiment;

FIG. 8 is a schematic showing the results of observation of the surface of an ITO film formed by a sputtering method by way of the atomic force microscope in an exemplary embodiment;

FIGS. 9A-9E are schematics showing the results of observation of the surface of the ITO film of various film thicknesses by way of the atomic force microscope in an exemplary embodiment;

FIG. 10 is a graph showing a relationship between a film-forming time and the film thickness in an exemplary embodiment; and

FIG. 11 is a graph showing a relationship between the film thickness of an ITO film, the average surface roughness Ra, as well as the maximum height difference in an exemplary embodiment.

### DETAILED DESCRIPTION OF EMBODIMENTS

Hereinafter, regarding the method of manufacturing the thin film element of the exemplary embodiments, a method of manufacturing an organic thin film element taken as an example will be described.

The method of manufacturing the organic thin film element of the exemplary embodiments is a method of manufacturing an organic thin film element that is constituted including an organic thin film between a pair of thin film electrodes provided with at least one transparent electrode. The method includes forming the transparent electrode onto a base material by atomizing a material liquid that contains a transparent-electrode forming material; and forming the organic thin film on the transparent electrode.

In the exemplary embodiment, because the material liquid containing the transparent-electrode forming material is atomized in fine mist, the material liquid that turned into particulate can penetrate into the microscopic concave portion of the surface of the base material even when the base material having the microscopic irregularities of the surface is used. Accordingly, the transparent electrode whose surface is approximately smooth can be obtained. Consequently, even when an organic thin film with a thin thickness is formed on the transparent electrode, it is possible to suppress the influences given to the shape of the surface of the organic thin film.

Here, the base material having microscopic irregularities in the surface includes the non surface-treated base materials in which the surface treatment such as polishing has not been carried out, or the base materials in which the surface treatment has been carried out, however it is not adequate to obtain the transparent electrode having a desired smoothness, for example. The size of the microscopic irregularities in the surface of the base material is not limited in particular because it also varies depending on the quality of the material of the base material to be used.

The method of atomizing such a material liquid is not limited in particular as long as it is a method of atomizing the material liquid in fine mist. One example is a Liquid Source Misted Chemical Deposition (LSMCD). According to this method, it is possible to easily form microscopic droplets in the order of microns or in the order of submicrons. Although here the mean particle diameter of the atomized material liquid is not limited in particular, it is desirable that the mean particle diameter is, for example, approximately 10 μm or less, preferably 5 μm or less, more preferably approximately 1 μm or less. With the particle diameter being in such a range, the particles made of the material liquid will penetrate inside the microscopic irregularities in the surface of the base material more easily. Accordingly, the smoothness of the formed transparent electrode tends to improve further. In addition, although the method of film-forming by using an ink-jet method is also known, a sufficient smoothness in the surface of the transparent electrode can not be attained even if film is formed in the surface of the base material in the conventional ink-jet method. Accordingly, a smoothing process such as the polishing of the surface of the transparent electrode is needed.

Here, the organic thin film element refers to an element constituted including an organic thin film between a pair of thin film electrodes. Specifically, the organic thin film element includes, for example, an organic-semiconductor element or the like. The organic semiconductor is a generic name for organic compounds that exhibit a semiconductive electrical conduction. The materials for forming the organic-semiconductor element include, for example, pentacene or the like.

Moreover, the organic-EL element refers to an element which emits light by applying an electric field to the organic luminescent layer thereby to excite the organic compound that constitutes the organic luminescent layer. Because the organic-EL element is the one having a structure in which the organic semiconductor is sandwiched between the thin film electrodes, and made by utilizing the organic semiconductor, the organic-EL element is assumed to be included in the organic-semiconductor element of the exemplary embodiments. The configuration of layers of the organic-EL element is not limited in particular, however, the following examples (1) through (8) are referred to. Note that, in the following examples (1) through (8), the configuration of the layers is described in the order of depositing the layers onto the substrate.
(1) An anode (a transparent electrode)/a hole transport layer/an organic luminescent layer/an electron-injection layer/a cathode (a mirror electrode);
(2) An anode (a transparent electrode)/a hole transport layer/an organic luminescent layer/a cathode (a mirror electrode);
(3) An anode (a transparent electrode)/an organic luminescent layer/an electron-injection layer/a cathode (a mirror electrode);
(4) An anode (a transparent electrode)/a hole transport layer/an organic luminescent layer/an adhesive layer/a cathode (a mirror electrode);
(5) An anode (a transparent electrode)/an organic luminescent layer/a cathode (a mirror electrode);
(6) An anode (a transparent electrode)/a mixed layer of a hole transport material, an organic luminescent material, and an electron-injection material/a cathode (a mirror electrode);
(7) An anode (a transparent electrode)/a mixed layer of a hole transport material and an organic luminescent material/a cathode (a mirror electrode);
(8) An anode (a transparent electrode)/a mixed layer of an organic luminescent material and an electron-injection material/a cathode (a mirror electrode).

In addition, including other layers, such as a hole-injection layer and an electron transport layer as required is not inhibited.

Moreover, the material used for such respective layers is not limited in particular. The material used for the respective layers will be described hereinafter. Method of manufacturing an organic-EL element

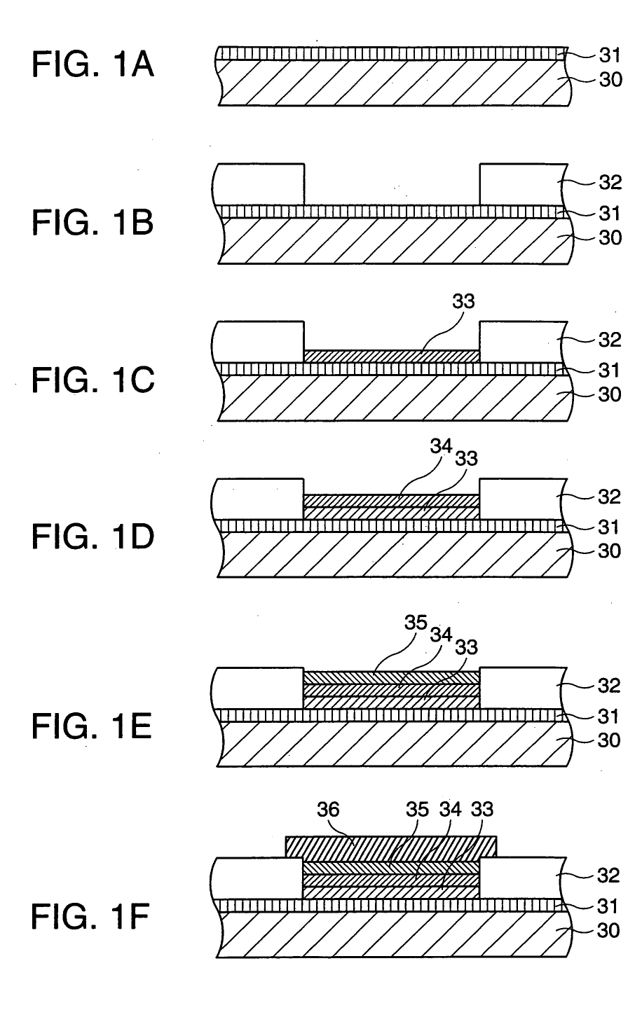

Hereinafter, one example of the method of manufacturing the organic thin film element of the exemplary embodiments will be described taking an example of the method of manufacturing an organic-EL element with reference to the accompanying drawings. FIGS. 1A-1F are schematics illustrating an example of the method of manufacturing the organic thin film element of the exemplary embodiments.

First, as shown in FIG. 1A, a transparent electrode 31 is formed by atomizing a material liquid containing a transparent-electrode forming material onto the whole surface of a substrate (base material) 30 by the LSMCD method.

Specifically, firstly the material liquid containing the transparent-electrode forming material is atomized onto the whole surface of the base material 30 by the LSMCD method, and after the film-forming, the transparent electrode 31 is formed by drying and annealing.

Here, although the quality of the material of the base material is not limited in particular, the transparent substrate made of, for example, glass or resin or the like is used. As the glass, a silica glass, a blue sheet glass, a borate glass, a silicate glass, a phosphate glass, a phosphorus silica glass, a borosilicate glass, or the like can be used. Moreover, as the resin, polyethylene terephthalate, polycarbonate, polyether sulfone, polyarylate, polymethacrylate, polyacrylate, polystyrene, or the like can be used.

According to the exemplary embodiments, the surface treatment such as polishing in particular may be carried out to the surface of the base material before forming the transparent electrode, however, it is also possible to directly form the transparent electrode without applying the surface treatment.

The material liquid used in this exemplary embodiment includes primarily the transparent-electrode forming material and a solvent. As the material liquid, the one made by dispersing the transparent-electrode forming material into the solvent or the one made by dissolving the same into the solvent may be used. Moreover, as the material liquid, it is preferable to use a liquid composed of a material having a high affinity with the base material. Thereby, the fluidity becomes excellent when the material liquid adheres to the surface of the base material, and thus the surface of the transparent electrode can be made smoother, and furthermore the adhesion to the base material becomes excellent. The material having a high affinity with the base material (or a target material intended to be adhered) includes the materials wherein adhesion between the transparent-electrode forming material contained in the material liquid and the base material (or a target material intended to be adhered) is excellent, in addition to the materials wherein wettability between the solvent contained in the material liquid and the base material (or a target material intended to be adhered) is excellent.

Moreover, as the transparent-electrode forming material, a metal, an alloy, an electrical conductivity compound, or their mixtures whose work function is high and with which a desired transparent electrode (a transparent electrode film) is obtained can be used. Specifically, a metal such as Au, and a dielectric transparent material such as ITO, SnO₂, and ZnO can be used suitably.

Moreover, the solvent for dispersing or dissolving the transparent-electrode forming material is not limited in particular, and is selected suitably from the viewpoints of affinity with the base material, and affinity with the transparent-electrode forming material. Although the magnitude of the contact angle, which is one of the indices of the affinity (wettability) with the base material of the solvent, is not limited in particular, it is preferable that the magnitude of the contact angle is small from the viewpoint of improving the fluidity of the solvent on the base material such that the solvent may spread easily and uniformly on the base material. For example, when an organic solvent is used as the solvent, the magnitude of the contact angle is set to 30° or less, preferably 25° or less, further preferably 20° or less. An example of the solvent used in this embodiment includes, specifically, THF, butyl acetate, hexane, cyclohexane, octane, toluene, or the like.

Additive agent, such as a dispersing agent, and stabilization agent other than the transparent-electrode forming material may be suitably contained in the material liquid as required.

The film thickness of the transparent electrode film to be formed is suitably changed depending on the design and is not limited in particular, however, it is set to, for example, 100 to 200 nm in the case of a general organic-EL element. For example, even when the transparent electrode with such thinness is formed in the base material whose surface roughness Ra is approximately 0.4 to 1.0 nm, the roughness Ra in the surface of the transparent electrode can be controlled to be 0.4 nm or less.

Then, as shown in FIG. 1B, an isolating film is formed of a silicon nitride or the like on the transparent electrode 31, and then a portion corresponding to a pixel region is removed by etching or the like thereby to form a bank 32 constituted of the isolating film.

Then, as shown in FIG. 1C, a hole transport layer 33 is formed by a vapor deposition or the like on the transparent electrode 31 that corresponds to the pixel forming region which is mutually isolated by this bank 32.

The material (a hole transport material) constituting the hole transport layer 33 includes, for example, a triazole dielectric, an oxadiazole dielectric, an imidazole dielectric, a poly aryl alkane dielectric, a pyrazoline dielectric, a pyrazolone dielectric, a phenylenediamine dielectric, an arylamine dielectric, an amino substitution chalcone dielectric, an oxazole dielectric, a styrylanthracene dielectric, and a fluorenone dielectric, a hydrazone dielectric, a stilbene dielectric, a silazane dielectric, a polysilane-system compound, an aniline-system copolymer, and specific conductive polymer oligomers such as thiofuranoligomer.

Then, as shown in FIG. 1D, on the hole transport layer 33, an organic luminescent layer 34 is further formed by a vapor deposition or an ink-jet method or the like.

The material (an organic luminescent material) constituting the organic luminescent layer 34 includes, for example, a fluorescent whitening agent of a system, such as a benzothiazole-system, a benzimidazole system, and a benzoxazole-system; a metal chelating oxynoid compound; a styrylbenzenoid compound; a distyrylpyrazine dielectric; and an aromatic dimethilysine compound, or the like. Moreover, the organic luminescent layer 34 is formed only by the organic luminescent material, and in addition may also be formed by a mixture of an organic luminescent material, a hole transport material and/or an electron-injection material, or the like. A specific example of the material of the organic luminescent layer 34 in this case includes: a molecular-dispersion polymer system wherein an organic luminescent material such as coumarin is dispersed into polymer, such as a poly-methyl methacrylate, a bisphenol A, and polycarbonate (PC); a polymer system wherein a distyrylbenzenedielectric is introduced into a polycarbonate frame; or a system wherein an oxadiazole-system dielectric having an electron-injection characteristic is dispersed into a conjugated polymer such as a polyphenylene vinyl (PPV) dielectric system, a poly alkyl thiophene (PAT) dielectric system, a poly alkyl fluorene (PAF) dielectric system, a poly phenylene (PP) dielectric system, and a poly arylene (PA) dielectric system, or into a poly vinyl carbazole having the hole transport characteristic.

Then, as shown in FIG. 1E, an electron-injection layer 35 is formed on the organic luminescent layer 34 by a vapor deposition.

The material (an electron-injection material) of the electron-injection layer 35 includes, for example, a nitration fluorenon dielectric, a anthraquinodimethan dielectric, a diphenyl quinone dielectric, a thiopyran dioxide dielectric, a heterocycle tetra carboxylic acid anhydride, such as a naphthalene perylen, carbodiimide, a fluorenylidene methane dielectric, an anthraquinodimethan dielectric, an anthrone dielectric, a oxadiazole dielectric, an 8-quinolinol dielectric, and other electron transport compounds, or the like

Then, as shown in FIG. 1F, the organic-EL element is obtained by forming a cathode layer (cathode) 36 on the electron-injection layer 35 by a vapor deposition method or a sputtering method or the like.

As the material of the cathode layer 36, a metal, an alloy, and an electrically conductive compound having a small work function, or their mixtures can be used, and specifically, sodium, magnesium, lithium, an alloy or a mixed metal of magnesium and silver, indium, a rare earth metal, or the like can be used suitably.

According to the method of manufacturing the organic-EL element of this exemplary embodiment, as described above, it is possible to form a transparent electrode whose film thickness is thin and whose surface is approximately flat and smooth, without receiving the surface irregularities on the base material, by adhering the atomized material liquid in fine mist with a microscopic particle size onto the base material.

Accordingly, because there will be no need to carry out the smoothing process by polishing or the like of the surface of the transparent electrode, the operation steps can be simplified, and thus shortening of the operation time and lowering of the cost can be attained.

Furthermore, because the surface of the transparent electrode is smoothed, and uniformity of the thickness of the layer which constitutes the organic thin film to be formed thereon will also be kept, the possibility that short-circuit or the like occurs can be reduced, and thus a thin film element having a long life can be formed easily.

Moreover, while, in the above-described example, the case where a glass substrate or a resin substrate is used as the base material has been described as an example, the one wherein a semiconductor element layer such as a TFT is formed on such a glass substrate or a resin substrate may be used as the base material.

Moreover, while in the above-described example an organic-EL element has been described as an example, the method of manufacturing the exemplary embodiments is not limited to this, but is also used in other methods of manufacturing an organic-semiconductor thin film element wherein smoothness of the surface of the transparent electrodes is important.

Modification 1

While in the above-described example the transparent electrode 31 is formed directly on the base material 30, a base film having a high affinity with the material liquid rather than with the base material 30 may be formed on the base material 30 to subsequently form the transparent electrode 31.

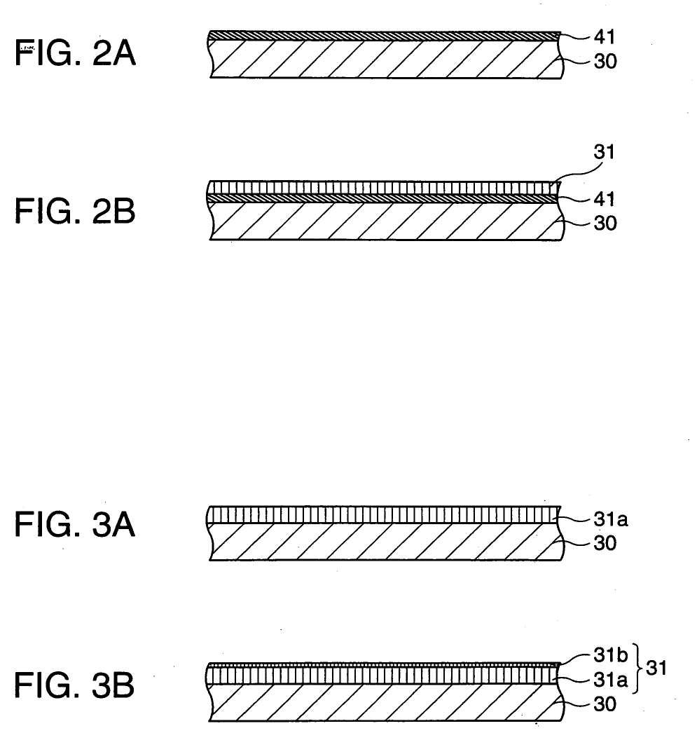

FIGS. 2A and 2B are schematics illustrating another example of the method of manufacturing the organic thin film element.

As shown in FIG. 2a, firstly a base film 41 is formed on the base material 30.

The method of forming the base film 41 is not limited in particular, but, for example, may be formed by a sputtering method or a vacuum deposition method.

As the material for forming the base film 41 (a base film-forming material), it is preferable to use the material having a high affinity (lyophilic) with the material liquid for forming the transparent electrode 31 rather than with the base material 30. By forming such a base film 41, the adhesion between the base material 30 and the transparent electrode 31 can be further enhanced. Accordingly, the base film forming material needs to be adjusted suitably in accordance with the relationship with the quality of the material of the base material 30 to be used, and with the relationship with the material liquid, and therefore is not limited in particular. Moreover, if the self-assembled monolayer is used as the base film 41, a stable film will be formed, and thereby affinity with the material liquid can be enhanced for a long period of time. Consequently, because a sufficient time before moving to the next processing can be kept, freedom in the processing steps will be increased. Such a self-assembled monolayer includes, for example, an aminopropyltriethoxy silane, a mercaptopropyltrieethoxy silane, or the like. The self-assembled monolayer can be formed easily by the application or the soaking, or the like, of a conventionally well-known liquid, for example, a liquid containing the material for forming the self-assembled monolayer.

Then, as shown in FIG. 2B, the transparent electrode 31 is formed on the formed base film 41. Hereafter, by carrying out the same processings as those in the steps shown in FIGS. 1A-1F, the organic-EL element can be obtained.

According to this example, the forming of the base film 41 allows the adhesion between the base material 30 and the transparent electrode 31 to be improved. Moreover, the use of the base film 41 having a high affinity (an excellent wettability) with the material liquid rather than with the base material 30 makes the spread (fluidity) of the material liquid excellent, enabling the contribution to the further smoothing of the surface of the transparent electrode.

Modification 2

FIGS. 3A and 3B are schematics illustrating another example of the method of manufacturing the organic-EL element.

As shown in FIG. 3A, firstly a first transparent electrode layer 31a is formed on the base material 30 by a forming method capable of film-forming (depositing) at a higher speed than the LSMCD method, such as a sputtering method or a spraying method.

Then, as shown in FIG. 3B, a second transparent electrode layer 31b is formed on the first transparent electrode layer 31a by the LSMCD method.

The transparent electrode layer 31 as the anode is composed of the first transparent electrode layer 31a and the second transparent electrode layer 31b. Here, although the film thickness of the first transparent electrode layer 31a is not limited in particular, preferably 50% or more of, further preferably 75% or more of, and especially preferably most of the desired film thickness of the transparent electrode layer 31 is formed by a method capable of film-forming (depositing) at a high speed. By forming most of the film thickness of the transparent electrode with the method capable of film-forming at a high speed, and by smoothing the surface with the LSMCD method, the throughput (the productivity) can be improved, and further the transparent electrode of which the surface condition is excellent can be obtained.

Moreover, as the material constituting the first transparent electrode layer 31a and the second transparent electrode layer 31b, the same material as the ones exemplified as the material for forming the above-described transparent electrode 31 may be used, and the material composing the first transparent electrode layer 31a and the second transparent electrode layer 31b may be the same or may differ.

An Electro-Optic Device and Electronic Equipment

The manufacturing method of the exemplary embodiment can be used suitably in the method of manufacturing an electro-optic device and electronic equipment. Namely, because the method of manufacturing an electro-optic device and electronic equipment of the exemplary embodiment uses the above-described method of manufacturing an organic-EL element (the organic thin film element), an electro-optic device and electronic equipment having a long life can be provided by a simple process.

Here, the electro-optic device is a device made by utilizing an electro-optical effect, and includes, for example, an organic-EL display device.

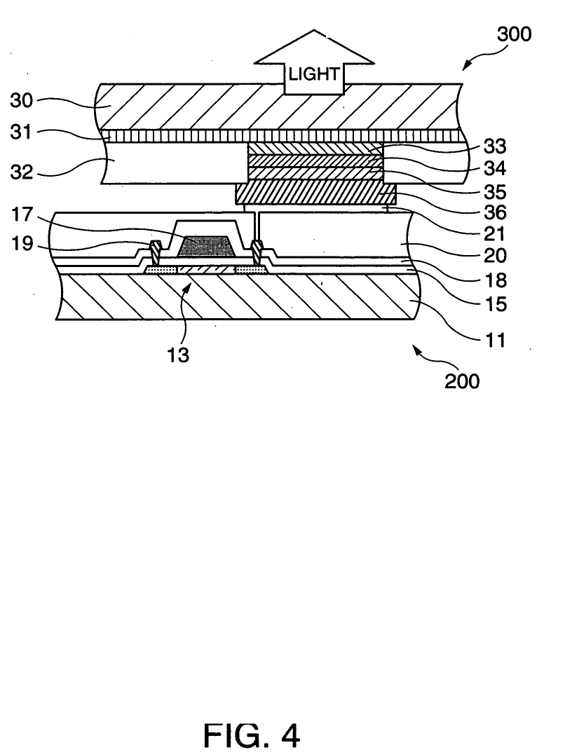

An example of the organic-EL device is shown in FIG. 4. As shown in FIG. 4, the organic-EL device can be formed by combining an organic-EL element 300 manufactured as described above with a substrate (hereinafter, also referred to as a TFT substrate) 200 in which thin film transistors are formed. Moreover, the TFT substrate 200 is mainly composed of a semiconductor film 13, an isolating film 15, a gate electrode 17, an inter-layer isolating film 18, a metal wiring 19, a protective layer 20, and a pixel electrode 21 on a substrate 11 made of glass, or the like.

The number of the organic-EL elements constituting the organic-EL device may be one or more than one. Moreover, when providing a plurality of organic-EL elements, the luminescent color of each organic-EL element may be the same or different, and thus one kind or more than one kind of the organic-EL element are formed in a desired shape so that the luminescent color as the whole organic-EL device becomes a desired color. For example, if making the luminescent color to be white, as the whole organic-EL device, an organic-EL element that emits a red light, an organic-EL element that emits a green light, and an organic-EL element that emits a blue light will be disposed in a stripe shape, in a mosaic shape, in a triangle shape, in a 4-pixel arranged shape, or the like. Because the luminescent color of each organic-EL element varies depending on the kind of the organic luminescent material, the type of the organic luminescent material to be used is selected suitably so that the luminescent color, as the whole organic-EL device may be the desired color.

Moreover, although the organic-EL display device of a top emission type has been exemplified in the above-described example, the organic-EL display device is not limited to this, and may be of a bottom emission type.

Moreover, while the above-described organic-EL element is formed on a substrate, one layer of, or two or more layers of protective layer for preventing moisture from intruding into the organic-EL element may be provided as to cover the organic-EL element formed on the substrate because the organic-EL element is usually vulnerable to moisture.

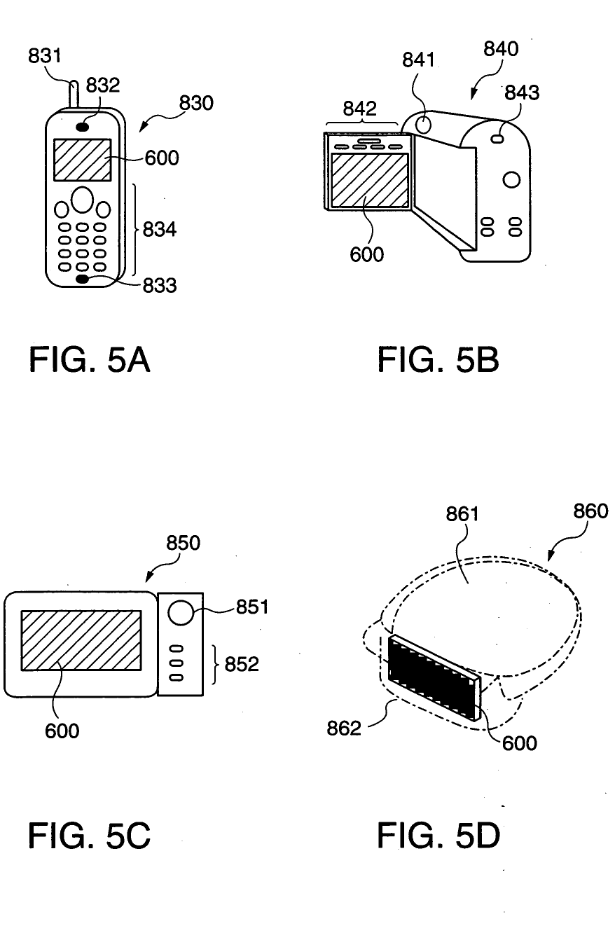

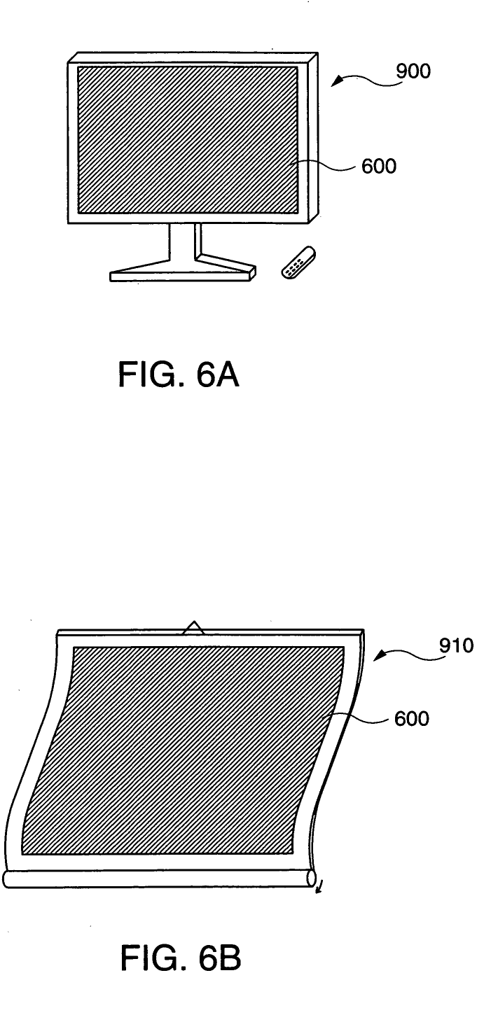

Moreover, such an organic-EL display device can be applied to various electronic equipments. FIG. 5 and FIG. 6 are views showing examples of various kinds of electronic equipments including an electro-optic device 600 (for example, an organic-EL display device).

FIG. 5A is an example applied to a cellular phone, and this cellular phone 830 is provided with an antenna section 831, a voice output section 832, a voice input section 833, an operating section 834, and the electro-optic device 600 of the exemplary embodiments. FIG. 5B is an example applied to a video camera, and this video camera 840 is provided with a picture receiving section 841, an operating section 842, a voice input section 843, and the electro-optic device 600. FIG. 5C is an example applied to a portable type personal computer (the so-called PDA), and this computer 850 is provided with a camera section 851, an operating section 852, and the electro-optic device 600. FIG. 5D is an example applied to a head-mounted display device, and this head-mounted display device 860 is provided with a band 861, an optical-system accommodation section 862, and the electro-optic device 600.

FIG. 6A is an example applied to a television, and this television 900 is provided with the electro-optic device 600. Moreover, the electro-optic device 600 can be applied in the same way to a monitor device used for a personal computer or the like. FIG. 6B is an example applied to a roll-up type television, and this roll-up type television 910 is provided with the electro-optic device 600.

Moreover, while in the above-described example the organic-EL display device was taken as one example of the electro-optic device, the exemplary embodiments are not limited to this, and is applicable to the method of manufacturing the electro-optic device using various other electro-optic elements (for example, a plasma emission element, an electrophoresis element, a liquid crystal element, or the like). Moreover, the electro-optic device can be applied not only to the above-described examples, but to a surface light source, a backlight of a liquid crystal display device or a clock, a character display device, a illumination device, an on-vehicle indicator, a light source for static elimination of a copying machine, a light source for a printer, and an electronic equipment such as a light modulation device.

### Exemplary Embodiment 1

First, a transparent glass substrate of 25×75×1.1 mm (with the surface roughness Ra of 0.55 μm) was prepared as the base material. Then, the film-forming is carried out onto the non surface-treated transparent glass substrate by the LSMCD method using an ITO precursor solution (manufactured by Kojyundo Chemical Laboratory Co., Ltd., the brand name: ITO-05C) which is to serve as the transparent electrode film (Indium-Tin-Oxide: ITO film) 31. After the film-forming, the drying process was carried out for 2 minutes at 120° C., and then by annealing at 550° C. the ITO film was formed. The film thickness of the ITO film was approximately 150 nm. Moreover, the surface roughness Ra of the ITO film was able to be controlled to 0.2 nm or less.

Then, the organic-EL element was obtained by forming the hole transport layer, the organic luminescent layer, and the cathode on the ITO film. Hereinafter, the method of forming the hole transport layer, the organic luminescent layer, and the cathode will be explained.

First, the glass substrate in which the ITO film is formed as described above was fixed to a substrate holder in a vacuum evaporation equipment, and then 200 mg of N,N′-diphenyl-N,N,N′-bis-(3-methyl phenyl)-[1,1′-biphenyl]-4,4′-diamine (hereinafter, referred to as TPD) was put in a molybdenum resistance heating boat, and 200 mg of tris-(8-quinolinol) aluminum (hereinafter, referred to as Alq) was put into another molybdenum resistance heating boat, and the inside of the vacuum chamber was decompressed down to 1×10⁻⁴ Pa.

Then, the above-described resistance heating boat into which the TPD is put was heated to 215 through 220° C. to deposit the TPD on the ITO film at the deposition rate of 0.1 through 0.3 nm/second and thus film-form the hole transport layer with the film thicknesses of 60 nm. The substrate temperature at this time was set at room temperature. Subsequently, the film-forming of the organic luminescent layer is continued without taking out from the vacuum chamber the substrate in which the hole transport layer is film-formed. Regarding the film-forming of the organic luminescent layer, the resistance heating boat in which Alq is put was heated to 275° C. to deposit the Alq on the hole transport layer at the deposition rate of 0.1 through 0.2 nm/second and film-formed the Alq layer with the film thickness of 50 nm. The substrate temperature at this time was also set at room temperature. Then, 1 g of magnesium being put into the molybdenum resistance heating boat, and 500 mg of indium being put into another molybdenum resistance heating boat, the inside of the vacuum chamber was decompressed to 2×10⁻⁴ Pa. Then, while the molybdenum resistance heating boats in which magnesium is put was heated to approximately 500° C. to evaporate the magnesium at the deposition rate of approximately 1.7 through 2.8 nm/second, the molybdenum resistance heating boat in which the indium is put was heated to approximately 800° C. to evaporate the indium at the deposition rate of approximately 0.03 through 0.08 nm/second, and thus the cathode (a mirror electrode) with the film thickness of 150 nm made of a mixed metal of magnesium and indium was formed on the organic luminescent layer. Thereby, the organic-EL element having the anode (ITO film), the hole transport layer, the organic luminescent layer, and the cathode formed on the substrate was obtained.

Moreover, here the non surface-treatment means that the surface smoothing process such as polishing, or the like, has not been carried out in particular, which is also the same in the following embodiments.

### Exemplary Embodiment 2

First, a transparent glass substrate of 25×75×1.1 mm was prepared as the base material. Then, an APTES film which is a self-assembled monolayer was formed by applying methanol containing 2% of an amino propyltriethoxy silane (APTES) onto the transparent glass substrate. Then, the transparent electrode film was film-formed on the APTES film by the LSMCD method using the ITO precursor solution (manufactured by Kojyundo Chemical Laboratory Co., Ltd., and the brand name: ITO-05C). After the film-forming, a drying process was carried out for 2 minutes at 120° C., and then by annealing at 550° C., the ITO film was formed. The film thickness of the ITO film was approximately 200 nm.

Then, like the exemplary embodiment 1, an organic-EL element was obtained by forming the hole transport layer, the organic luminescent layer, and the cathode on the ITO film.

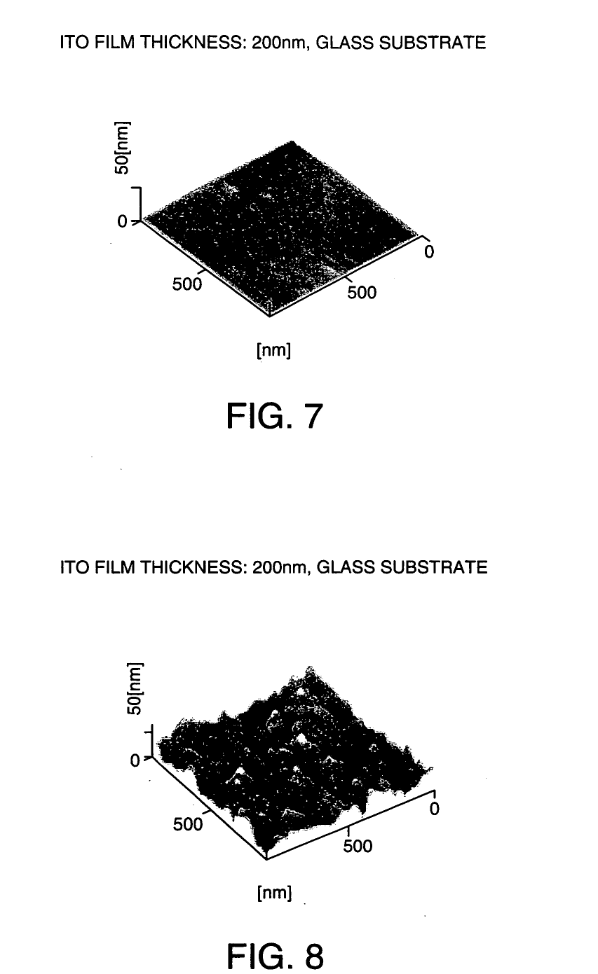

FIG. 7 shows the results of observation of the surface of the ITO film by means of an atomic force microscope. The average surface roughness Ra of the obtained ITO film was 0.2 μm, and the maximum height difference was 2.51 nm.

### Exemplary Embodiment 3

First, a transparent glass substrate of 25×75×1.1 mm was prepared as the base material. Then, an ITO film with the film thickness of 100 μm was film-formed on the transparent glass substrate as a first transparent electrode layer constituting the anode by a sputtering method. Then, a second transparent electrode film was film-formed on this first transparent electrode layer by the LSMCD method using the ITO precursor solution (manufactured by Kojyundo Chemical Laboratory Co., Ltd., and the brand name: ITO-05C). After the film-forming, a drying process was carried out for 2 minutes at 120° C., and then by annealing at 550° C. the ITO film was formed. The film thickness of the ITO film combining the first transparent electrode layer with the second transparent electrode layer was approximately 150 nm.

Then, like the exemplary embodiment 1, the organic-EL element was obtained by forming the hole transport layer, the organic luminescent layer, and the cathode on the ITO film.

According to the exemplary embodiment 3, by forming the first transparent electrode layer and the second transparent electrode layer with different methods, the transparent electrode having an excellent smoothness of the surface and having the equal film thickness was able to be formed more quickly than the case where the film-forming was carried out only with the LSMCD method.

### COMPARATIVE EXAMPLE 1

First, a transparent glass substrate of 25×75×1.1 mm was prepared as the base material. Then, an ITO film with the film thickness of 200 μm was film-formed on the transparent glass substrate as a first transparent electrode layer comprising the anode by a sputtering method.

Then, like the exemplary embodiment 1, the organic-EL element was obtained by forming the hole transport layer, the organic luminescent layer, and the cathode on the ITO film.

FIG. 8 shows the results of observation of the surface of the ITO film by means of the atomic force microscope. The average surface roughness Ra of the obtained ITO film was 7.33 nm, and the maximum height difference was 61.1 nm.

Comparing FIG. 7 with FIG. 8, sufficient smoothness in the surface of the ITO film could not be obtained by the sputtering method even if the transparent electrode film (the ITO film) of the same film thickness (200 nm) was formed on the same substrate.

### REFERENCE EXAMPLE

The relationship between the film thickness of the transparent electrode film (the ITO film) formed by means of the LSMCD method and the surface roughness of the ITO film was studied.

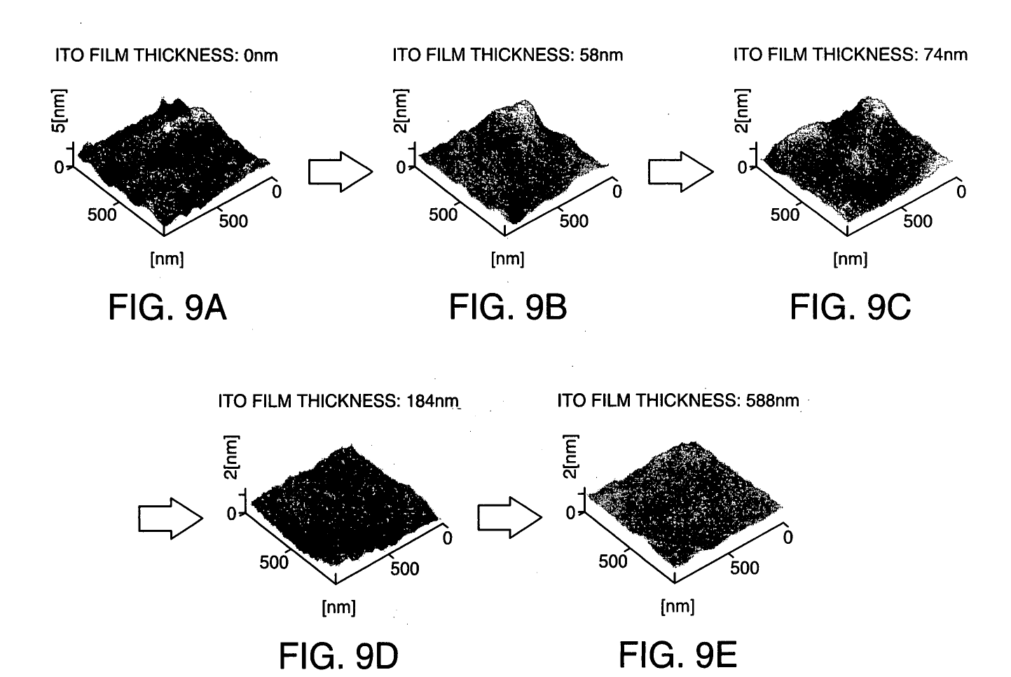

The ITO film was formed on the substrate like the exemplary embodiment 1 except that the film thickness of the ITO film was changed variously by adjusting the film-forming time of the ITO precursor solution. The surface of each ITO film was observed by means of the atomic force microscope. The results are shown in FIGS. 9A-9E.

FIG. 9A shows the condition that the ITO film has not been formed yet (the ITO film thickness: 0 nm). In FIG. 9A, the ups and downs of the surface irregularities appears significant, however, it is apparent that the ups and downs of the surface irregularities decrease as the film thickness of the ITO film is made thicker to 58 nm (refer to FIG. 9B), 74 nm (refer to FIG. 9C), and 184 nm (refer to FIG. 9D). Moreover, even when the film thickness of the ITO film is made extremely thick to 588 nm (refer to FIG. 9E), it is apparent that the ups and downs of the surface irregularities in FIG. 9D almost does not vary. It is therefore considered that no dramatic changes will be produced in the smoothness of the surface from around a little over 184 nm even if making the thickness thicker.

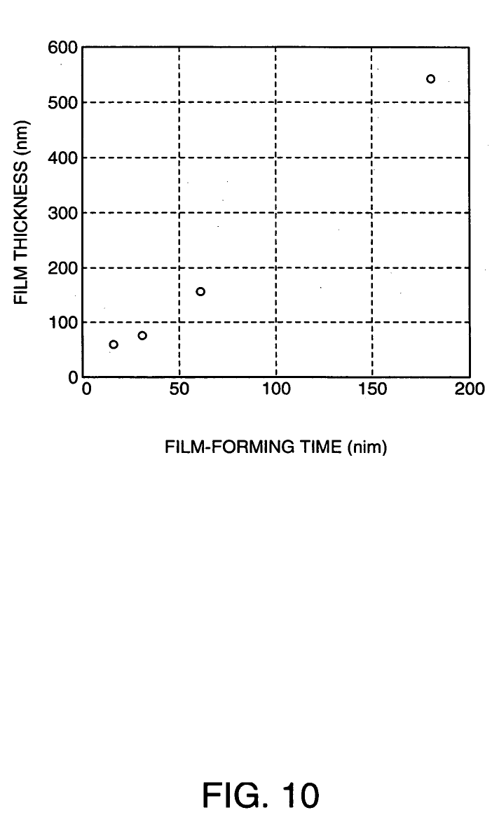

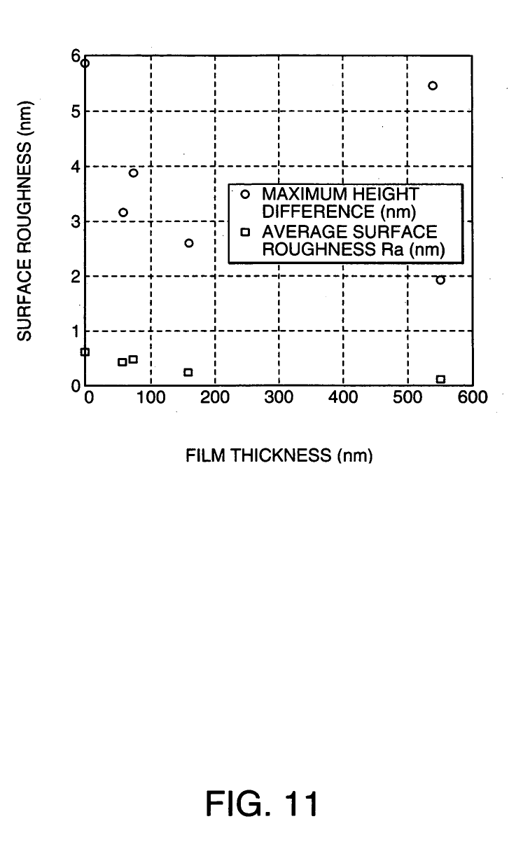

The relationship between the film-forming time and the film thickness is shown in FIG. 10, and the relationship between the film thickness, and the average surface roughness Ra as well as the maximum height difference of the surface of the ITO film is shown in FIG. 11.

As shown in FIG. 10, there is the relationship of being almost constant between the film-forming time and the film thickness, and thus the film thickness can be controlled in accordance with the film-forming time. If looking at the maximum height difference of the ITO film at each film thickness obtained this way, it is understood that the smoothness of the surface is remarkably improved due to the film thickness until the film thickness reaches the vicinity of 100 nm, however, as the film thickness exceeds the vicinity of 200 nm, the degree of the improvement in the smoothness of the surface tends to be moderate (refer to FIG. 11).

What is claimed is:

1. A method of manufacturing an organic thin film element including an organic thin film between a pair of thin film electrodes having at least one transparent electrode, the method comprising:
atomizing a material liquid that contains a transparent-electrode forming material onto a base material to form the transparent electrode; and
forming the organic thin film on the transparent electrode.

2. The method of manufacturing an organic thin film element according to claim 1, a liquid composed of a material having a high affinity with the base material being used as the material liquid.

3. The method of manufacturing an organic thin film element according to claim 1, a film having a high affinity with the material liquid rather than with the base material is formed on the base material as the base film for the transparent electrode.

4. The method of manufacturing an organic thin film element according to claim 3, the base film being a self-assembled monolayer.

5. The method of manufacturing an organic thin film element according to claim 1, the transparent electrode layer being deposited in advance on the base material by a method other than the atomizing, before the film-forming of the transparent electrode by the atomizing.

6. The method of manufacturing an organic thin film element according to claim 5, the method other than the atomizing being a sputtering method or a spraying method.

7. The method of manufacturing an organic thin film element according to claim 1, wherein the particle diameter of the atomized material liquid being 10 μm or less.

8. The method of manufacturing an organic thin film element according to claim 1, a non surface-treated base material being used as the base material.

9. The method of manufacturing an organic thin film element according to claim 1, the organic thin film element being an organic thin film semiconductor element.

10. The method of manufacturing an organic thin film element according to claim 1, the organic thin film element being an organic electroluminescence element.

11. A method of manufacturing an electro-optic device including the method of manufacturing an organic thin film element according to claim 1.

12. A method of manufacturing electronic including the method of manufacturing an organic thin film element according to claim 1.
